(19) United States
(12) Patent Application Publication
(10) Pub. No.: US 2015/0199714 A1
(43) Pub. Date: Jul. 16, 2015

(54) CUSTOMIZED IN-FLIGHT MERCHANDISING PROCESS OVER A COMMUNICATIONS NETWORK

(71) Applicant: Farelogix Inc., Miami, FL (US)

(72) Inventors: Tim Reiz, Miami, FL (US); Vitali Ruppel, Miami, FL (US)

(73) Assignee: Farelogix Inc., Miami, FL (US)

(21) Appl. No.: 14/152,636

(22) Filed: Jan. 10, 2014

(51) Int. Cl. G06Q 30/02

(52) U.S. Cl. CPC G06Q 30/0251

(57) ABSTRACT

A method for providing an in flight merchandising process to a consumer is disclosed. The method includes storing a flight record that includes at least a unique identifier, a destination identifier and a current flight status, and storing an offer record that includes at least an offer for a good or service. The method further includes reading a unique identifier associated with the flight, and accessing a particular flight record associated with the unique identifier. The method further includes identifying offer records that correspond to the particular flight record by executing offer rules that define offer records that correspond to a destination identifier and current flight status of the particular flight record, and transmitting each of the offers for a good or service from the offer records that were identified, wherein each of the offers for a good or service are formatted for in flight display for the consumer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field of electronic commerce and, more specifically, the present invention relates to the field of customized and targeted offers over communications networks.

### BACKGROUND OF THE INVENTION

With the emergence of small and mobile computing devices, and the wide availability of high speed network connections, increased opportunities to provide merchandise and other offers to customers have arisen. One arena where these opportunities have been embraced is the commercial airline industry. Financial troubles and a desire to provide the most economical prices for their customers have led the airline industry to seek additional ways of generating revenue while still meeting their customers' needs and increasing consumer satisfaction.

In flight merchandising systems allow customers to purchase items while sitting in their seats during a commercial flight. Today, in flight merchandising systems allow customers to purchase movies, food and other goods and services while enjoying a flight to their destination. These systems have increased revenue, as well as consumer satisfaction. But existing in flight merchandising systems are static and simple in that they only provide a predefined list of goods and services that do not change during a flight. Further, existing in flight merchandising systems offer the same predefined list of goods and services to all of the passengers on a flight, or over different flights. There is no customization or personalization of the goods and services offered. With the airline industry currently seeking to establish closer relationships with their customers and drive greater loyalty between consumers and airline brands, greater and more extensive contact and interaction with customers is sought during the point of sale process, especially during a flight.

Therefore, a need exists to overcome the problems with the prior art, and more specifically, there is a need for a more extensive and improved system and method for providing an in flight merchandising process over a communications network.

### BRIEF SUMMARY OF THE INVENTION

The disclosed embodiments present a method for providing an in flight merchandising process to a consumer over a communications network. The method includes storing, in an associated database, a flight record for each of a plurality of flights, wherein a flight record includes at least a unique identifier, a destination identifier and a current flight status, and storing, in the associated database, an offer record for each of a plurality of offers, wherein an offer record includes at least an offer for a good or service. The method further includes reading, over the communications network, a unique identifier associated with the flight, and accessing, in the associated database, a particular flight record associated with the unique identifier. The method further includes identifying one or more offer records that correspond to the particular flight record by executing one or more offer rules that define one or more offer records that correspond to a destination identifier and current flight status of the particular flight record, and transmitting, over the communications network, each of the offers for a good or service from the one or more offer records that were identified, wherein each of the offers for a good or service are formatted for in flight display for the consumer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the network architecture of a system for providing an in flight merchandising process to a consumer over a communications network, in accordance with one embodiment.

FIG. 2A is a block diagram illustrating the data flow of the in flight merchandising process provided to a consumer over a communications network, in accordance with one embodiment.

FIG. 2B is a block diagram illustrating the data flow of the algorithm for identifying pertinent offers, which is a part of the in flight merchandising process provided to a consumer over a communications network, in accordance with one embodiment.

FIG. 3 is a flow chart depicting the general control flow of the process for providing an in flight merchandising process to a consumer over a communications network, according to one embodiment.

FIG. 4 is a block diagram of a system including an example computing device and other computing devices.

### DETAILED DESCRIPTION OF THE INVENTION

The disclosed embodiments improve upon the problems with the prior art by providing a system that allows for quick and easy targeted advertising to in-flight consumers over a mobile communications network. The disclosed embodiments leverage existing network-enabled in-flight entertainment systems to provide additional merchandising opportunities to consumers and offer them a growing number of options that can make a trip more comfortable for travelers and more productive for corporations. An additional benefit of the disclosed embodiments is the potential to establish closer relationships with consumers and drive greater loyalty between airline brands and end customers. Further, by merchandising services such as in-flight Wi-fi, extra legroom and preferred seating, day passes in the airline lounge, premium luggage service with delivery and more, airlines can place greater emphasis on personalization according to a traveler's needs and provide greater choice throughout the travel experience.

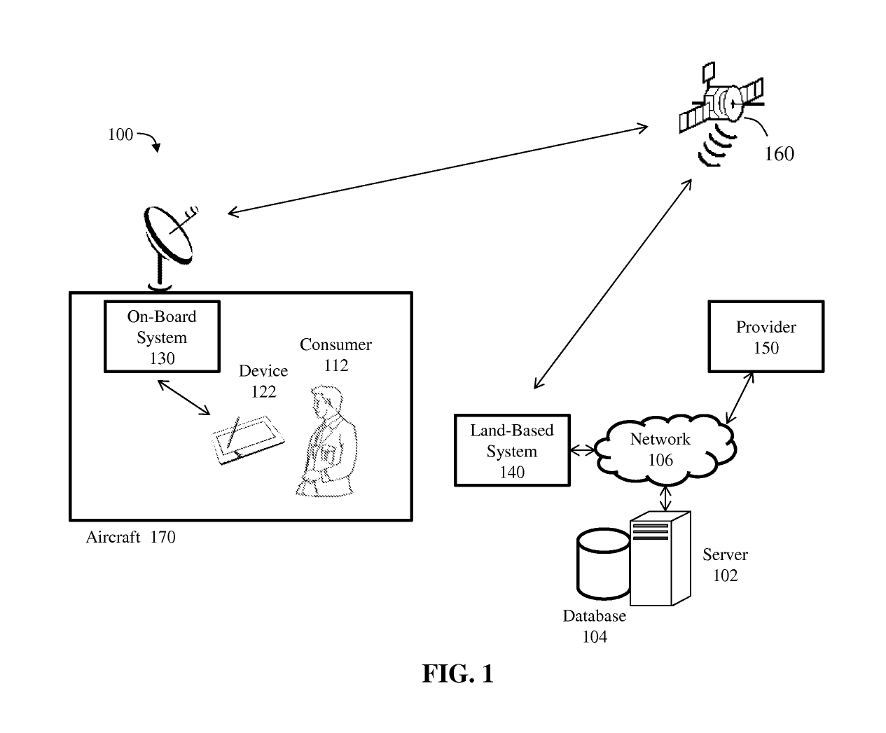

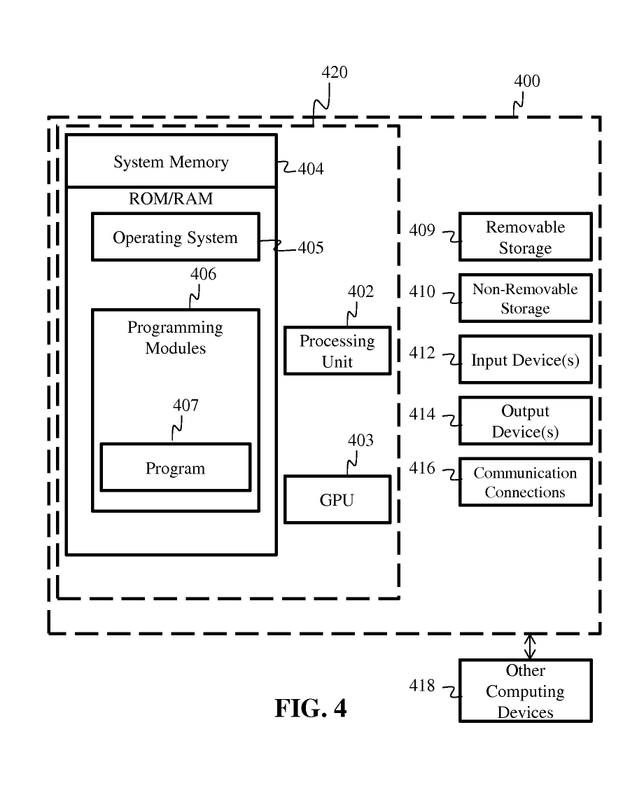

Referring now to the drawing figures in which like reference designators refer to like elements, there is shown in FIG. 1 an illustration of a block diagram showing the network architecture of a system 100 and method for providing an in flight merchandising process to a consumer over a communications network in accordance with one embodiment. FIG. 1 shows an aircraft 170, such as a commercial airliner, which includes an on-board Internet or WiFi system 130. On-board system 130 provides consumers 112 on the aircraft 170 with in-flight wired, wireless, WiFi and/or other access to the Internet or network 106. Consumer 112 accesses the network 106 via his computing device 122, which may be an in flight entertainment system console, a mobile computing device, smart phone, mobile phone, handheld computer, laptop, server, workstation, desktop computer, computer terminal, workstation, or the like. The on-board system 130 may connect to the network 106 via a series of links including a connection to a satellite 160, which, in turn, connects to a land-based relay point 140 that connects to the network 106. Alternative to a satellite connection, the on-board system 130 may connect to the network 106 via a serious of series of links including a connection to land based radio towers. Examples of device 122 are described in greater detail below with reference to FIG. 4

FIG. 1 further shows various components coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Connected to network 106 is server 102, which substantially encompasses the process of providing in flight merchandising opportunities to a consumer 112 over communications network 106, as described in greater detail below. Also connected to network 106 is provider 150, which may be an in-flight provider of goods and services for consumer 112, such as an airline, a travel services provider, a ticketing provider, a travel agency, a transportation provider, a travel bookings provider, or the like. Server 102 and provider 150 may each include a software engine that delivers applications, data, program code and other information to networked computing devices, such as device 122. Examples of server 102 and provider 150 are described in greater detail below with reference to FIG. 4.

FIG. 1 further shows a database or repository 104, which may be a relational database comprising a Structured Query Language (SQL) database stored in a SQL server. The repository 104 serves data from a database, which is a repository for data used by server 102 and device 122 during the course of operation of the invention. Database 104 may be distributed over one or more nodes or locations that are connected via network 106.

The database 104 may include consumer records, which are records that contain the details of a consumer 112. A consumer record 260 may include: a unique consumer identifier, contact/identifying information for the consumer or passenger (name, address, telephone number(s), email address, etc.), additional passenger contact details, passenger age details, passenger frequent flyer data, special service request codes (special meals, etc.), optional services instruction, other service information, vendor remarks, the passenger's gender, passenger passport details, date and place of the passenger's birth, redress number, all available payment/billing information and one or more references to a flight record, such as a unique flight record identifier.

A consumer record may also include a passenger's status (such as elite status, gold status, silver status, local customer status, etc.), which refers to a passenger's position or standing with the airline. Passenger status may also include whether the passenger has paid for an annual subscription to an awards program or whether the passenger is a member of a particular loyalty program. Passenger status may include whether the passenger has a particular status with another airline or with a consortium of airlines or travel providers. Certain benefits, such as free upgrades and free airport lounge stays, are often provided to passengers with a high status, for example. A consumer record may also include the passenger's history with the airline, which may refer to how many years the passenger has flown with the airline, the number of flights the passenger has taken with the airline, the monetary amount the passenger has spent with the airline, the passenger's purchase history, etc. Airlines often provide incentives and benefits to passengers with a long history with the airline, for example.

A consumer record may further include passenger name records, which are records in the database of a computer reservation system that contains the itinerary for a passenger, or a group of passengers travelling together. A passenger name record may include: contact/identifying information for the passenger, contact/identifying information for the travel agent or airline ticket office that generated the ticket (if any), the passenger's seat number, ticketing details such as a ticket number of a ticketing time limit, an itinerary for at least one travel segment, the name of the person providing the information or making the booking, a timestamp, the booking agency's pseudo-city code, a unique all alpha or alpha-numeric record locator, fare details and any restrictions that may apply to the ticket, and the like.

The database 104 may also include flight records, which are records that contain the details of a particular commercial flight. A flight record 262 may include: a unique flight identifier, a passenger information list, references to consumer or passenger records, a flight manifest, seat numbers for all passengers on the flight, an itinerary, an itinerary for at least one travel segment, a departure identifier, a destination identifier, an airline identifier, flight time/date, flight departure time/date, flight arrival time/date, current flight status, and the like. Current flight status data refers to the current status or state of a flight, such as in-flight, on the ground, at the gate, etc., but also its current time status, such as delayed, cancelled, 15 minutes late, 20 minutes early, on hold, etc. Current flight status data may also include time data, such as modified flight time/date, flight departure time/date, flight arrival time/date, etc.

The database 104 may also include offer records, which are records that contain the details of a particular offer for goods or services. An offer record 264 may include: a unique offer identifier, a product or service description, a good or service type, a location identifier, a monetary price at which the good or service is offered, an image of the product or service, a discount price, an expiration date and time for the offer, etc. Examples of offers would be a free stay at an airport lounge at a particular airport, a free seat upgrade on the next flight, a movie that is watched in-flight at no charge, a free hotel stay at a particular hotel in a particular city, etc.

The database 104 may include fare records, which are records in the database of the computer reservation system that contains the details of a fare. Fare records may be associated with a consumer record and or a flight record. A fare record may include: the departure and arrival cities, airports or pseudo-city codes of the fare, the airline providing the fare, a timestamp, the prices associated with the fare, dates and times associated with the fare, fare details and any restrictions that may apply to the ticket, optional services instruction, other service information, vendor remarks, passenger name records or references/pointers to same, etc. The database 104 may also include fare rule records, which are rules that describe how fares are applied and may be changed. Fare rule records may also be associated with a consumer record and or a flight record. A fare rule record may include: blackout dates, memberships in organizations, identities of credit card issuers, additional services that may apply, upgrades that may apply, and any of the data that may be included in a fare record. Fare rule records may also include travel days, sales dates, flight restrictions, mileage restrictions, journey time, applicable regions, etc. In one embodiment, one or more portions of consumer records, offer records, flight records, fare records and fare rule records may be combined into one or more records.

The database 104 may also include a lookup table 280 that defines a correspondence between one or more current flight statuses and one or more good or service types. The lookup table may comprise a two-column array wherein, for each row, a current flight status (or more than one) is/are listed in the first column and the corresponding good or service type(s) is/are listed in the second column. Alternatively, the database 104 may include offer rules 285 that define how offers are targeted to consumers. The offer rules 285 may also define a correspondence between one or more current flight statuses and one or more good or service types. A rule may be an if-then statement that defines certain facts or attributes that must be present (the if-portion) in order for an offer to be provided to a consumer (the then-portion). The if-portion may define one or more particular current flight statuses, a destination identifier and/or a location identifier. The then-portion may comprise one or more offers (or links or references to offers records) that correspond to the in-portion. For example, a rule may state that if a flight to Boston Airport is delayed more than one hour, then the following offer is provided to a consumer: a free 4 hour stay in the airport lounge in Boston Airport.

It should be noted that although FIG. 1 shows only server 102, one database 104, one provider 150, one device 122 and one on-board system 130, the disclosed embodiments support any number of servers, databases, providers, devices, and on-board systems connected via network 106. Also note that although one server 102 is shown as a single and independent entity, in one embodiment, the functions of the server 102 may be integrated with another entity, such as provider 150. Further, server 102 and its functionality, according to a preferred embodiment, can be realized in a centralized fashion in one computer system or in a distributed fashion wherein different elements are spread across several interconnected computer systems. Likewise, provider 150 and its functionality, can be realized in a centralized fashion in one computer system or in a distributed fashion wherein different elements are spread across several interconnected computer systems.

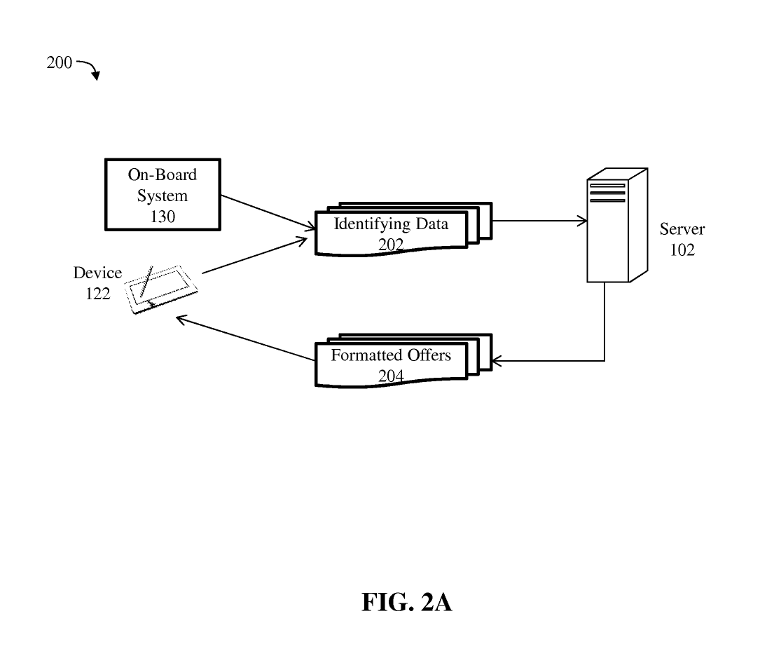

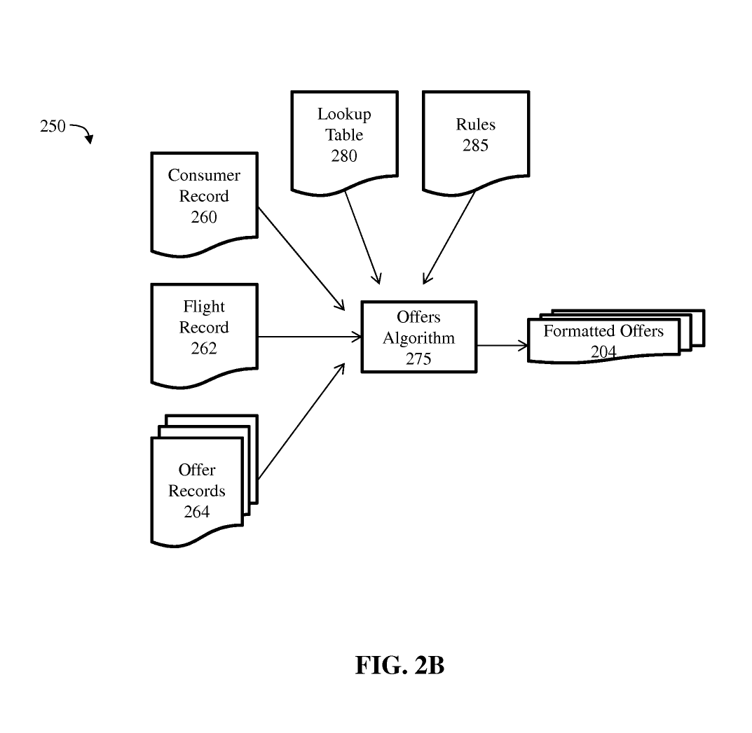

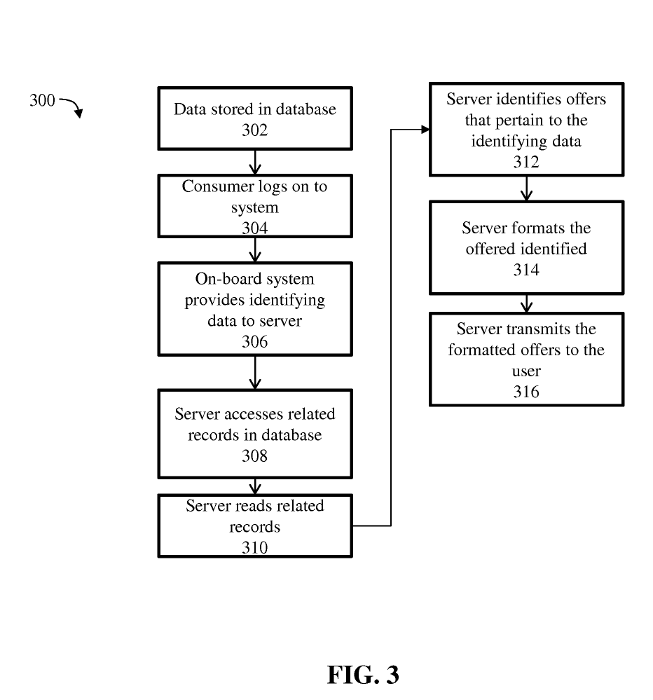

The process of providing in flight merchandising to a consumer over a communications network 106 will now be described with reference to FIGS. 2A through 3 below. FIGS. 2A through 3 depict, among other things, the data flow and control flow in the process for providing in flight merchandising to a consumer 112 over a communications network 106, according to one embodiment. The process of the disclosed embodiments begins with step 302 (see flowchart 300), wherein the server 102 stores all consumer records, flight records and offer records in the database 104. Subsequently, the server 102 performs any necessary processing of the data in the database 104, such as indexing, compressing, organizing, etc. In one example, when recording a record, the server 102 includes direct references and/or linked lists among records, thereby avoiding map lookup at runtime. In another example, when recording a record, the server 102 transforms records into compressed structures.

In step 304, the consumer 112 uses his device 122 to log on to the on-board system 130 and, by extension, to the network 106 via the satellite 160 and land-based system 140. The consumer 112 may log on to the on-board system 130 by entering identifying data 202 (such as any of the data in a consumer record, or flight record) into a graphical user interface (GUI) in his device 122. For example, the consumer may log on by selecting a WiFi point to which to connect, via a GUI, and entering data 202 into a GUI that is presented after the WiFi point is selected. In step 304, the consumer 112 may provide to on-board system 130 certain data pertaining to the consumer, such as any of the data stored in a consumer record or flight record, such as a name, flight confirmation number, flight number, seat number, etc.

In step 306, the on-board system 130 and/or device 122 provides identifying data 202 to the server 102. The identifying data 202 may comprise some or all of the data 202 provided by the consumer 112 in step 304, such as a unique flight identifier, a unique consumer identifier or both. In one embodiment, the data 202 is provided to server 102 via TCP/IP and/or HTTP over network 106. In an alternate embodiment, prior to step 304, the on-board system 130 had internally stored certain identifying data 202, such as a unique flight identifier, or any other data stored in a flight record. In this alternate embodiment, in step 306 the data 202 provided to server 102 comprises some or all of the previously stored data. In yet alternate embodiment, in step 306 the data 202 provided to server 102 comprises some or all of the data previously stored by system 130 (such as a flight number), and data provided by the consumer 112 (such as a name, record locator, etc.).

In step 308, the server 102 uses the identifying data 202 to access flight records and/or consumer records from the database 104. If the identifying data 202 includes a unique flight identifier (such as a flight number), the server 102 uses the identifier to access a corresponding flight record 262 in the database 104. If the identifying data 202 includes a unique consumer identifier (such as a passenger name, record locator, seat number, etc.), the server 102 uses the identifier to access a corresponding consumer record 260 from the database 104. Subsequently, the server 102 reads a unique flight identifier in the consumer record 260 and uses the unique flight identifier to access a corresponding flight record 262. Either way, the result of step 308 is that the flight record corresponding to the flight on which consumer 112 is located is accessed by server 102.

In step 310, the server 102 reads all or some of the data in the flight records and/or consumer records that were read from the database 104. For example, the server 102 may read, from a flight record, the destination identifier and current flight status of the flight on which consumer 112 is located. Alternatively, the server 102 may read, from a consumer record, the passenger's status, passenger's history and seat number or location. The aforementioned data may be read from a particular flight record 262 or a consumer record 260.

In step 312, the server 102 executes the offers algorithm 275 (described in more detail below), which identifies one or more offer records in the database 104 that correspond to the data read in step 310. In step 314, the server 102 formats the offers for a good or service, from the one or more offer records that were identified, for in-flight display by the consumer 112 on device 122. The formatting step may include, for example, generating HTML that is customized to the device 122 of consumer 112. For example, the server 102 may employ responsive web design, which is a web design methodology aimed at crafting web sites and data to provide an optimal viewing experience—easy reading and navigation with a minimum of resizing, panning, and scrolling—across a wide range of devices.

In step 316, the server 102 transmits, over the communications network 106 (and via system 140, satellite 160 and system 130), each of the formatted offers 204 for a good or service, wherein each of the offers for a good or service are formatted for in flight display for the consumer 112. In one embodiment, in step 316, the formatted offers 204 are transmitted from server 102 to the device 122 via the land-based system 140, satellite, 160 and on-board system 130.

In one embodiment, algorithm 275 on the server 102 identifies one or more offer records 264 in the database 104 that corresponds to the particular flight record 262 by comparing the destination identifier and current flight status of a particular flight record 262 to the good or service type and location identifier in each of the plurality of offer records 264. Recall that the database 104 may also include a lookup table 280 that defines a correspondence between one or more current flight statuses and one or more good or service types. Thus, the algorithm 275 may match the destination identifier of a particular flight record 262 to the location identifier in each of the plurality of offer records 264, and, using the lookup table 280, the algorithm 275 may match the current flight status of a particular flight record 262 to the good or service type of the plurality of offer records 264. When the algorithm finds a match between the data in the particular flight record 262 to the data in one or more of the plurality of offer records 264, the matched offer record or records is/are identified as such. Said matched offer records are used to generate the formatted offers 204.

Alternatively, the offer rules 285 may also define a correspondence between one or more current flight statuses and one or more good or service types. The offer rules 285 may define when certain offers are provided to a consumer. For example, if a consumer's flight to Miami is delayed by more than one hour, then a free upgrade on the consumer's next flight may be offered.

Examples of offers for goods and services would be offers to sell on-board Wi-Fi, transportation at a destination, hotel rooms at a destination, extra legroom and preferred seating on the current or other flights, day passes in an airline lounge, premium luggage service with delivery, etc. An example of a correspondence between a current flight status and a good or service type in the lookup table 280 is a correspondence between a delayed flight status and a day pass in an airline lounge. Since a late flight often means that a traveler will miss his connecting flight, staying in an airline lounge during the delay is a welcome offer. Another example of a correspondence between a current flight status and a good or service type in the lookup table is a correspondence between a delayed flight status and a hotel room in the departure location. Since a delayed flight often means that a traveler will miss his connecting flight and have to stay at the connecting location for a night, staying in a hotel during the extra night is a welcome offer.

In an alternate embodiment, algorithm 275 on the server 102 identifies one or more offer records 264 in the database 104 that corresponds to a particular consumer record 260. The offer rules 285 may also define a correspondence between a passenger status or passenger history and one or more offers. The offer rules 285 may define when certain offers are provided to a consumer, based on his passenger status or passenger history. For example, if a consumer has elite status in his consumer record, he may be offered a free airport lounge stay at this destination city.

Following is one example of how the method 300 may be executed. In step 302, the server 102 stores all consumer records, flight records and offer records in the database 104. In step 304, the consumer 112 uses his device 122 to log on to the on-board system 130 and, by extension, to the network 106 via the satellite 160 and land-based system 140. The consumer 112 logs on to the on-board system 130 by entering his full name into a graphical user interface (GUI) in his device 122. In step 306, the on-board system 130 provides the consumer's full legal name to the server 102. In step 308, the server 102 uses the consumer's full legal name to access a corresponding consumer record 260 from the database 104. Subsequently, the server 102 reads a unique flight identifier in the consumer record 260 and uses the unique flight identifier to access a corresponding flight record 262. In step 310, the server 102 reads (from record 260) the destination identifier (is this case “MIA” for Miami, Fla.) and current flight status of the flight on which consumer 112 is located (in this case “Delayed over one hour”).

In step 312, the server 102 executes the offers algorithm 275, which identifies one or more offer records in the database 104 that correspond to the data read in step 310. The algorithm 275 accomplishes this by matching the destination identifier (“MIA”) to the location identifier in each of the plurality of offer records 264, and, using the lookup table 280, by matching the current flight status (“Delayed over one hour”) to the good or service type of the plurality of offer records 264. In this example, the algorithm finds one offer that matches the destination identifier (“MIA”) and the current flight status (“Delayed over one hour”). The offer is for an airport lounge stay at a discounted rate.

In step 314, the server 102 formats the matching offer for in-flight display by the consumer 112 on device 122. In step 316, the formatted offer is transmitted from server 102 to the device 122 via the land-based system 140, satellite, 160 and on-board system 130.

As a second example, below is an alternate description of steps 308-312 of the method 300. In step 308, the server 102 uses the consumer's full legal name (or seat number, or record locator) to access a corresponding consumer record 260 from the database 104. Subsequently, in step 310, the server 102 reads a passenger status or “elite” in the consumer record 260. In step 312, the server 102 executes the offers algorithm 275, which executes offer rules 285. A particular offer rule states that if a consumer has “elite” status, then a particular offer (of the plurality of offer records 264)—a free upgrade on the next flight—is provided.

FIG. 4 is a block diagram of a system including an example computing device 400 and other computing devices. Consistent with the embodiments described herein, the aforementioned actions performed by servers 102 and 150 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2A-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), nonvolatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2A-3 above. Computing device 402 may also include a graphics processing unit 403, which supplements the processing capabilities of processor 402 and which may execute programming modules 406, including all or a portion of those processes and methods shown in FIGS. 2A-3 above The aforementioned processes are examples, and processing units 402, 403 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a land-based server including a processor, the method for providing in flight merchandising offers to a consumer on a flight over a communications network, comprising:
storing, by the processor, in an associated land-based database, a flight record for each of a plurality of flights, wherein a flight record includes at least a unique identifier, a destination identifier and a current flight status, which comprises current time status;
storing, by the processor, in the associated land-based database, an offer record for each of a plurality of offers, wherein an offer record includes at least an offer for a good or service;
reading, by the processor, over the communications network, a unique identifier associated with a flight, wherein the unique identifier was received from an in-flight computing device during said flight;
accessing, by the processor, in the associated land-based database, a particular flight record associated with the unique identifier;
identifying, by the processor, one or more offer records that correspond to the particular flight record by executing one or more offer rules that define one or more offer records that correspond to a destination identifier and current flight status of the particular flight record;
transmitting, by the processor in real-time, over the communications network to the in-flight computing device during said flight, each of the offers for a good or service from the one or more offer records that were identified, wherein each of the offers for a good or service are formatted for in flight display for the consumer.

2. The method of claim 1, wherein the step of storing a flight record further comprises:
storing, in the associated database, a flight record for each of the plurality of flights, wherein a flight record includes at least a unique identifier, a departure identifier, a destination identifier, an airline identifier, flight time, flight departure time, flight arrival time, and a current flight status.

3. The method of claim 2, wherein the step of storing an offer record further comprises:
storing, in the associated database, an offer record for each of a plurality of offers, wherein an offer record includes at least an offer for a good or service, a good or service type and a location identifier, wherein an offer for a good or service comprises a monetary price and a description of a good or service.

4. The method of claim 3, wherein the step of reading a unique identifier further comprises:
reading, over the communications network, a unique identifier comprising an alphanumeric data string associated with the flight.

5. The method of claim 4, wherein the step of reading a unique identifier further comprises:
reading, over the communications network, a TCP-IP request that includes a unique identifier comprising an alphanumeric data string associated with the flight.

6. The method of claim 4, wherein the step of identifying one or more offers that correspond to the particular flight record further comprises:
executing one or more offer rules, wherein each rule comprises an if-portion that defines a destination identifier and a current flight status, and a then portion that defines one or more offer records;
wherein a particular one of the one or more offer rules defines one or more offer records that correspond to the destination identifier and current flight status of the particular flight record.

7. The method of claim 6, wherein the step of transmitting each of the offers further comprises:
formatting each of the offers for a good or service from the one or more offer records that were identified for in flight display, so as to produce one or more formatted data structures; and
transmitting, over the communications network, the one or more formatted data structures for in flight display for the consumer.

8. A method on a land-based server including a processor, the method for providing in flight merchandising offers to a consumer on a flight over a communications network, comprising:
storing, by the processor, in an associated land-based database, a consumer record for each of a plurality of consumers on a flight, wherein a customer record includes at least a unique consumer identifier, and a reference to a flight record pertaining to the flight;
storing, by the processor, in an associated land-based database, a flight record for each of a plurality of flights, wherein a flight record includes at least a destination identifier and a current flight status, which comprises current time status;
storing, by the processor, in the associated land-based database, an offer record for each of a plurality of offers, wherein an offer record includes at least an offer for a good or service;
reading, by the processor, over the communications network, a unique consumer identifier associated with the consumer, wherein the unique consumer identifier was received from an in-flight computing device during a flight;
accessing, by the processor, in the associated land-based database, a particular consumer record associated with the unique identifier and a particular flight record associated with the particular consumer record;
identifying, by the processor one or more offer records that correspond to the particular flight record by executing one or more offer rules that define one or more offer records that correspond to a destination identifier and current flight status of the particular flight record; and
transmitting, by the processor in real-time, over the communications network to the in-flight computing device during said flight, each of the offers for a good or service from the one or more offer records that were identified, wherein each of the offers for a good or service are formatted for in flight display for the consumer.

9. The method of claim 8, wherein the step of storing a consumer record further comprises:
storing, in the associated database, a consumer record for each of a plurality of consumers on a flight, wherein a customer record includes at least a customer name, a reference to a flight record pertaining to the flight, a departure identifier, a destination identifier, and a unique consumer identifier;

10. The method of claim 9, wherein the step of storing a flight record further comprises:
storing, in the associated database, a flight record for each of the plurality of flights, wherein a flight record includes at least a unique identifier, a departure identifier, a destination identifier, an airline identifier, flight time, flight departure time, flight arrival time, and a current flight status.

11. The method of claim 10, wherein the step of storing an offer record further comprises:
storing, in the associated database, an offer record for each of a plurality of offers, wherein an offer record includes at least an offer for a good or service, a good or service type and a location identifier, wherein an offer for a good or service comprises a monetary price and a description of a good or service.

12. The method of claim 11, wherein the step of reading a unique identifier further comprises:
reading, over the communications network, a unique identifier comprising an alphanumeric data string associated with the consumer.

13. The method of claim 12, wherein the step of reading a unique consumer identifier further comprises:
reading, over the communications network, a TCP-IP request that includes a unique consumer identifier comprising an alphanumeric data string.

14. The method of claim 13, wherein the step of identifying one or more offers that correspond to the particular flight record further comprises:
executing one or more offer rules, wherein each rule comprises an if-portion that defines a destination identifier and a current flight status, and a then portion that defines one or more offer records;
wherein a particular one of the one or more offer rules defines one or more offer records that correspond to the destination identifier and current flight status of the particular flight record.

15. The method of claim 14, wherein the step of transmitting each of the offers further comprises:
formatting each of the offers for a good or service from the one or more offer records that were identified for in flight display, so as to produce one or more formatted data structures; and
transmitting, over the communications network, the one or more formatted data structures for in flight display for the consumer.

16. A land-based computer system for providing in flight merchandising offers to a consumer on a flight over a communications network, comprising:
a land-based database for storing a consumer record for each of a plurality of consumers on a flight, wherein a customer record includes at least a unique consumer identifier, and a passenger status, and for storing an offer record for each of a plurality of offers, wherein an offer record includes at least an offer for a good or service;
a memory;
a network interface device communicatively coupled with the communications network; and
a processor configured for:
reading, over the network interface device, a unique consumer identifier associated with the consumer, wherein the unique consumer identifier was received from an in-flight computing device during a flight;
accessing in the land-based database a particular consumer record associated with the unique consumer identifier;
identifying one or more offer records that correspond to the particular consumer record by executing one or more offer rules that define one or more offer records that correspond to a passenger status of the particular consumer record and current flight status of the flight, wherein current flight status includes current time status; and
transmitting in real-time, over the network interface device to the in-flight computing device during said flight, each of the offers for a good or service from the one or more offer records that were identified, wherein each of the offers for a good or service are formatted for in flight display for the consumer.

17. The computer system of claim 16, wherein a consumer record further comprises:
a customer name, a reference to a flight record pertaining to the flight, a departure identifier, and a destination identifier.

18. The computer system of claim 17, wherein an offer for a good or service further comprises:
a monetary price and a description of a good or service.

19. The computer system of claim 18, wherein the memory further comprises:
a distributed memory.
